(19) United States
(12) Patent Application Publication
(10) Pub. No.: US 2016/0259630 A1
(43) Pub. Date: Sep. 8, 2016

(54) SYSTEMS, APPARATUS AND METHODS FOR SHARING VISUAL MODEL-BASED APPLICATIONS

(71) Applicant: Mendix B.V., Rotterdam (NL)

(72) Inventors: Derek Peter ROOS, Winchester, MA (US); Derckjan KRUIT, Rotterdam (NL); Roald KRUIT, Numansdorp (NL); Johannis DEN HAAN, Zwijndrecht (NL); Andrej KOELEWIJN, Den Haag (NL); Marinus Cornelis WESTSTRATE, Roosendaal (NL); Erik Bastiaan Robbert VAN DE POL, Schiedam (NL); Meinte BOERSMA, Leiden (NL); Arjan Ferdinand BLOK, Krimpen Aan Den Ijssel (NL)

(21) Appl. No.: 15/061,089

(22) Filed: Mar. 4, 2016

Related U.S. Application Data
(60) Provisional application No. 62/128,835, filed on Mar. 5, 2015.

(51) Int. Cl. G06F 9/44; G06F 3/0482; G06F 3/0484; G06F 17/30; H04L 29/06

(52) U.S. Cl. CPC G06F 8/36; G06F 17/30882; G06F 17/30864; H04L 63/102; G06F 3/04842; G06F 3/0482; G06F 3/04845

(57) ABSTRACT

The present disclosure relates to systems, methods, and apparatus for enabling sharing and/or collaboration on visual model-based applications. Visual model-based applications can be represented using an internal representation, which can be edited and read in a visual modeling environment, or using a visual representation, which visually depict the model-based application in a visually intuitive way. A model share server can receive internal representations of visual model-based applications and convert them into visual representations for display on a hosted webpage, or for display on an external webpage or document. The model share server can also generate visual representations in such a way that preserves key words or text for indexing by a search engine crawler, which facilitates searching of visual model-based applications.

### CROSS-REFERENCE TO RELATED APPLICATIONS

This application claims the benefit under 35 U.S.C. §119(e) of Provisional Application No. 62/128,835, filed Mar. 5, 2015, entitled “SYSTEMS, APPARATUS AND METHODS FOR SHARING VISUAL MODELS OF APPLICATIONS,” the entire contents of which are incorporated by reference here in their entirety.

### TECHNICAL FIELD

This application relates to systems, methods and apparatus for enabling sharing and/or collaboration on computer application models.

### BACKGROUND

Computer applications for use in computing devices, such as mobile devices, personal computers (PCs), and/or enterprise-level systems, can be designed and built in modeling environments. Modeling environments can be computer programs that facilitate creating or editing computer applications. Examples of modeling environments include CADCAM software, electronic circuit design software, and UML, BPEL, and BPMS tools. Computer applications being designed in modeling environments are typically stored in the form of non-human-readable code (e.g., internal representations). These files can only be properly viewed and edited in modeling environments.

Computer applications can be created, edited, and/or represented using traditional source code, such as Java, C++, C, Flash, Python, Perl, etc. Computer applications can also be created, edited, and/or represented within modeling environments using visual representations (or visual models) that visually depict how the application's logic flows. These visual representations can comprise, for example, flow-charts or decision trees that show a user how the application will operate. The visual representations can also visually depict data that is to be received from the user, data that is to be stored, and data that is to be displayed to the user. These visual representations can also be interactive, which allows a user to manipulate the model in an intuitive way (e.g., by expanding or hiding branches of logic, zooming in/out, copying/pasting branches of logic from one section of the model into another, etc.)

The Internet enables collaboration on models, but mostly on written source code. However, sharing of visual model-based applications over the Internet is unresolved. For example, one difficulty with enabling collaboration on visual model-based applications is that internal representations of such applications (for use within modeling environments) cannot be easily indexed by search engines, and so can be hard to search for and locate. It can also be difficult to easily share visual model-based applications outside the context of a modeling environment.

### SUMMARY

One aspect of this disclosure is directed at making visual model-based applications as easy to comprehend, share and reuse as script-based applications. In another aspect, the present disclosure is directed at systems, apparatus and methods for enabling collaboration on visual model-based applications.

Aspects of collaboration that are addressed in this disclosure include: copy/pasting visual model-based applications from one modeling environment to another, uploading visual model-based applications to the web, translating internal representations of such applications into visual representations of applications, translating visual representations into internal representations, displaying or providing information regarding visual model-based applications on the web according to a requested or appropriate format (e.g., on a standard web browser), facilitating displaying of interactive visual representations of visual model-based applications on web browsers, facilitating indexing of visual model-based applications by regular search engines, and finding such models through regular online search engines.

According to one aspect, the present disclosure is directed at a system for facilitating sharing of a visual model-based application over a network. The system can comprise: a communication interface configured to communicate with at least an uploading user and a downloading user over the network; at least one memory; and at least one processor. The at least one processor can be configured to: receive, from the uploading user, via the communication interface, an internal representation defining an operation of the application, wherein the internal representation is configured to be read and edited by a visual model-based application modeling environment, convert the internal representation into a visual representation of the application, wherein the visual representation visually depicts a logic flow associated with the internal representation, the logic flow comprising one or more elements that are configured to interact with a viewing user, store the received internal representation and the visual representation into the at least one memory, and provide, via the communication interface, at least one of the visual representation and the internal representation to the downloading user.

According to some embodiments, the at least one processor can be further configured to generate a first resource identifier associated with the internal representation, and a second resource identifier associated with the visual representation; host a webpage that displays the first resource identifier and the second resource identifier; provide the internal representation in response to a request associated with the first resource identifier; and provide the visual representation in response to a request associated with the second resource identifier.

According to some embodiments, the visual representation can comprise Scale Vector Graphics (SVG) elements.

According to some embodiments, the second resource identifier can be an HTML object configured to be embedded in an external webpage or document.

According to some embodiments, the at least one processor can be further configured to provide a sitemap resource to a search engine web crawler. The sitemap resource can include including links to keywords that characterize at least one of the internal representation and the visual representation. The sitemap resource can also itself include keywords that characterize at least one of the internal representation and the visual representation.

According to some embodiments, the at least one processor can be further configured to receive and verify an identity and a credential associated with at least one of the uploading user and the downloading user.

According to some embodiments, the one or more elements can be configured to interact with a viewing user by displaying more or less text when clicked on.

According to some embodiments, the one or more elements can be configured to interact with a viewing user by being configured to allow the user to move the one or more elements from one part of the visual representation to another part of the visual representation.

According to some embodiments, the visual model-based application can comprise an application module configured to be combined with other application modules.

According to another aspect, the present disclosure is directed at a method for facilitating sharing of a visual model-based application over a network. The method can comprise: receiving, at at least one processor from an uploading user via a network, an internal representation defining an operation of the application, wherein the internal representation is configured to be read and edited by a visual model-based application modeling environment; converting, at the at least one processor, the internal representation into a visual representation of the application, wherein the visual representation visually depicts a logic flow associated with the internal representation, the logic flow comprising one or more elements that are configured to interact with a viewing user; storing the received internal representation and the visual representation into at least one memory; and providing, via the network, at least one of the visual representation and the internal representation to a downloading user.

According to some embodiments, the method can further comprise: generating a first resource identifier associated with the internal representation, and a second resource identifier associated with the visual representation; hosting a webpage that displays the first resource identifier and the second resource identifier; providing the internal representation in response to a request associated with the first resource identifier; and providing the visual representation in response to a request associated with the second resource identifier.

According to some embodiments, the visual representation can comprise Scale Vector Graphics (SVG) elements.

According to some embodiments, the second resource identifier can be an HTML object configured to be embedded in an external webpage or document.

According to some embodiments, the method can further comprise providing a sitemap resource to a search engine web crawler, the sitemap resource including links to keywords that characterize at least one of the internal representation and the visual representation. The sitemap resource can also itself include keywords that characterize at least one of the internal representation and the visual representation.

According to some embodiments, the method can further comprise receiving and verifying an identity and a credential associated with at least one of the uploading user and the downloading user.

According to some embodiments, the one or more elements can be configured to interact with a viewing user by displaying more or less text when clicked on.

According to some embodiments, the one or more elements can be configured to interact with a viewing user by being configured to allow the user to move the one or more elements from one part of the visual representation to another part of the visual representation.

According to some embodiments, the visual model-based application can comprise an application module configured to be combined with other application modules.

### BRIEF DESCRIPTION OF THE DRAWINGS

FIG. 1 is a conceptual block diagram illustrating a relationship between an internal representation of a model and one or more visual representations of the model, according to some embodiments.

FIG. 2 depicts an exemplary visual representation of a computer application or model, according to some embodiments.

FIG. 3 is a conceptual block diagram illustrating some of the components of a system for editing, saving, and sharing visual and internal representations of models, according to some embodiments.

FIG. 4 is a conceptual block diagram depicting a model share server in greater detail, according to some embodiments.

FIG. 5 is a view of an exemplary webpage that can be hosted by a model view service of the model share server, according to some embodiments.

FIG. 6 is a flowchart depicting an exemplary process for uploading, saving, and sharing internal and visual representations of models, according to some embodiments.

FIG. 7 is a flowchart depicting an exemplary process for reusing a previously uploaded model, according to some embodiments.

FIG. 8 is a flowchart depicting an exemplary process for viewing a visual representation of a model that was previously uploaded and/or generated, according to some embodiments.

FIG. 9 is a flowchart depicting an exemplary process for embedding a visual representation of a model into an external webpage or document, according to some embodiments.

FIG. 10 is a data flow diagram that depicts an exemplary data flow progression associated with an indexing operation by a web crawler, according to some embodiments.

FIG. 11 is a data flow diagram that depicts an exemplary data flow progression associated with an indexing operation of an external webpage or document by a web crawler, according to some embodiments.

### DETAILED DESCRIPTION

Computer applications can be created, edited, and represented using traditional source code. Examples of such traditional source code include C, C++, Java, Flash, Python, Perl, and other script-based methods of representing a computer application. Sharing of such script-based applications, or parts of such script-based applications can be accomplished by sending, posting or sharing snippets of code, potentially along with a short description of the code's functionality.

Computer applications can also be created, edited, and represented using visual model based representations. Unlike traditional source code implementations, such computer applications can be created, edited, and/or represented by drawing, moving, connecting, and/or disconnecting visual depictions of logical elements within a visual modeling environment. Visual-model based representations of computer applications can use symbols, shapes, lines, colors, shades, animations, and/or other visual elements to represent logic, data or memory structures or user interface elements. In order to program a traditional script-based application, programmers are typically required to type out detailed scripts according to a complicated set of programming syntax rules. In contrast, programming a visual model-based application can, in some embodiments and in some cases, be done by connecting various logical elements (e.g., action blocks and/or decision blocks) to create a visual flow chart that defines the application's operation. Similarly, defining data structures (e.g., variable types, database objects, or classes) and/or user interface elements (e.g., dropdown boxes, lists, text input boxes) in a visual model-based application can be done by drawing, placing, or connecting visual depictions of logical elements within a virtual workspace, as opposed to typing out detailed commands in a script. Visual-model based computer applications can therefore be more intuitive to program and/or edit compared to traditional script-based applications.

The present disclosure is directed at systems, apparatus, and methods for sharing visual model-based representations of computer applications. One way to share information regarding visual model-based applications is to send, share, or post a static picture, such as a .jpeg, .gif, or .pdf file, of the visual model-based application. However, this method generally does not preserve all the information required to compile and execute a visual model-based application. Simply taking a screenshot of a program as it appears in a visual modeling environment, for instance, would not preserve invisible metadata that lies behind the visual symbols, shapes, lines, colors, and shades on the screen. One would not be able to import the screenshot into a modeling environment at another system and expect the computer application to execute and run.

Another way to share visual model-based applications is to translate the visual model-based application into a traditional source code script, and then send, share, or post that translated script. Optionally, programmers that receive such translated scripts can convert the translated script back into a visual model-based application. However, current methods of translating visual model-based applications into traditional source code tend to be error-prone and can result in programs that do not run efficiently. This translation process often necessitates time-consuming debugging of the resulting script-based program. Similarly, current methods of translating traditional source code applications into visual model-based applications also tend to be error-prone and time-consuming to implement. What is needed, therefore, is a system or platform for sharing visual model-based applications that does not require visual model-based applications to be translated into script-based applications, and vice versa.

For brevity, references to a “model,” a “visual model,” or an “application” should be understood to refer to visual model-based applications unless specifically indicated. In some cases, such visual model-based applications can represent complete, stand-alone computer applications for execution on a computer system. Visual model-based applications can also represent discrete modules that are configured to perform certain tasks or functions, but which do not represent complete computer applications—instead, such discrete modules can be inserted into a larger computer application, or combined with other discrete modules to perform more complicated tasks. Example of such discrete modules can include modules for validating a ZIP code, for receiving information regarding current weather from a weather feed, and/or for rendering graphics.

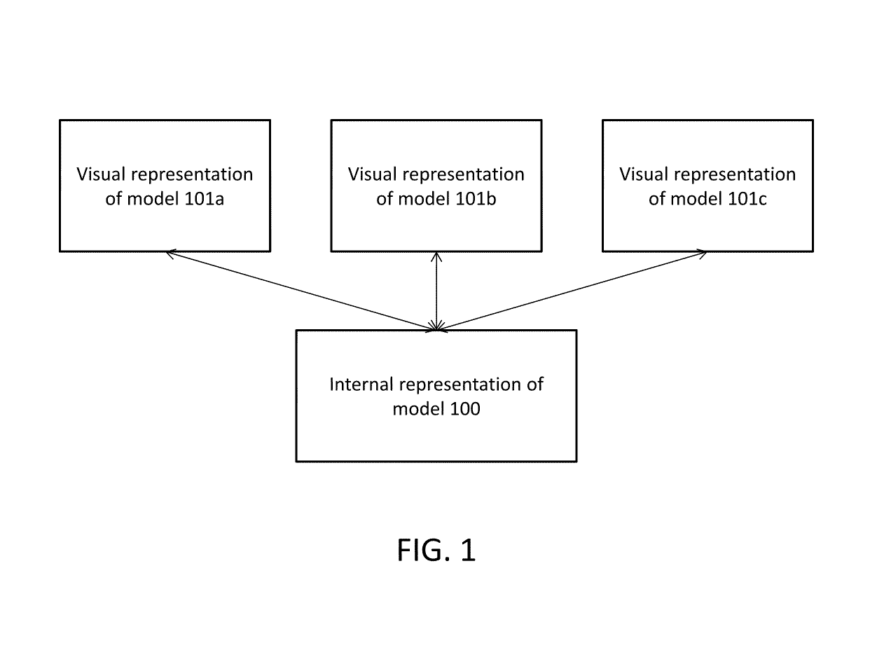

Visual models can be represented in two forms: an internal representation and one or more associated visual representations. FIG. 1 is a conceptual block diagram illustrating a relationship between an internal representation of a model (or part of a model) and one or more visual representations of the model, according to some embodiments. The internal representation 100 can be a file encoded according to a file format used by a modeling environment to capture and define the operation of an application (or part of an application). For example, the internal representation 100 can define what inputs an application can receive, what outputs an application can provide, the algorithms and operations by which the application can arrive at results, what data the application can display, what data the application can store, etc. The internal representation 100 can also be used to instruct an execution environment how to execute the logic of the application during runtime. Internal representation 100 can be stored in the form of non-human-readable code (e.g., binary code). Internal representation 100 can also be stored according to a binary stored JSON (java script object notation) format, and/or an XML format. At run-time, an execution engine can use internal representation 100 to compile and/or generate executable machine code that, when executed by a processor, causes the processor to implement the functionality of the model.

The internal representation 100 can be associated with one or more visual representations, depicted in FIG. 1 as visual representations 101a, 101b, and 101c. Visual representations can comprise visual elements that depict how an application's logic flows, but which are not designed to be compiled or executed. These visual representations can comprise, for example, flow-charts or decision trees that show a user how the application will operate. The visual models can also visually depict data that is to be received from the user, data that is to be stored, and data that is to be displayed to the user. These visual models can also be interactive, which allows a user to manipulate the model in an intuitive way. For example, visual representations can be configured to display a certain level of detail (e.g., number of branches, number of displayed parameters, granularity of displayed logic) by default. However, users can interact with the visual representation in order to show a desired level of detail—for example, users can display or hide branches of logic, and/or display or hide sets of parameters. In some embodiments, details relating to an element of the visual model can be hidden from view by default, but can appear in a sliding window or pop-up that appears on-screen when the user clicks on the appropriate element. Users can also zoom in or out of the model, and/or pan across different parts of the model, to examine different parts of the model. In some embodiments, users can also copy or paste branches of logic from one section of the model into another section, or copy/paste branches of logic from a first model into a second model. In some cases, parts of the model can contain links to other parts of the model, such that if a user clicks on a link, the user will automatically be led to another part of the model. In some embodiments, a viewing user can interact with a visual representation in at least some of the same ways that the viewing user might interact with the model if it were displayed within a modeling environment. In other words, the visual representation can be configured to mimic how the model would appear if it were displayed within a visual modeling environment. A single internal representation 100 can correspond to multiple visual representations that use different styles or formatting rules to display application logic. For instance, multiple visual representations corresponding to the same internal representation can differ from one another in their use of color, elements that are included or omitted, and use of symbols, shapes, lines, colors, and/or shades to depict logic flow.

Users can modify the internal representation of a model 100 by editing it within a modeling environment. However, it can be difficult for users to view or modify the internal representation directly, outside of a modeling environment, as internal representations of models usually take the form of non-human-readable code. Therefore, while the internal representation 100 can comprehensively define the operations of an algorithm, the internal representation 100 suffers from limitations that limit online collaboration. For example, the binary internal representation cannot be shared or viewed in web pages in a meaningful, intuitive way. Neither can internal representations be indexed by search engines for meaningful information. As such, internal representations of models can be difficult to search for.

As described above, in prior known systems, users can sometimes export visual models from modeling environments as raw, static (e.g., non-interactive) images. However, these images typically do not preserve the text in the model, and thus can be hard for regular search engines (e.g., Google) to index and search. The static images also limit user interaction with the model by, for example, eliminating the ability for users to hide/unhide or copy/paste branches of logic.

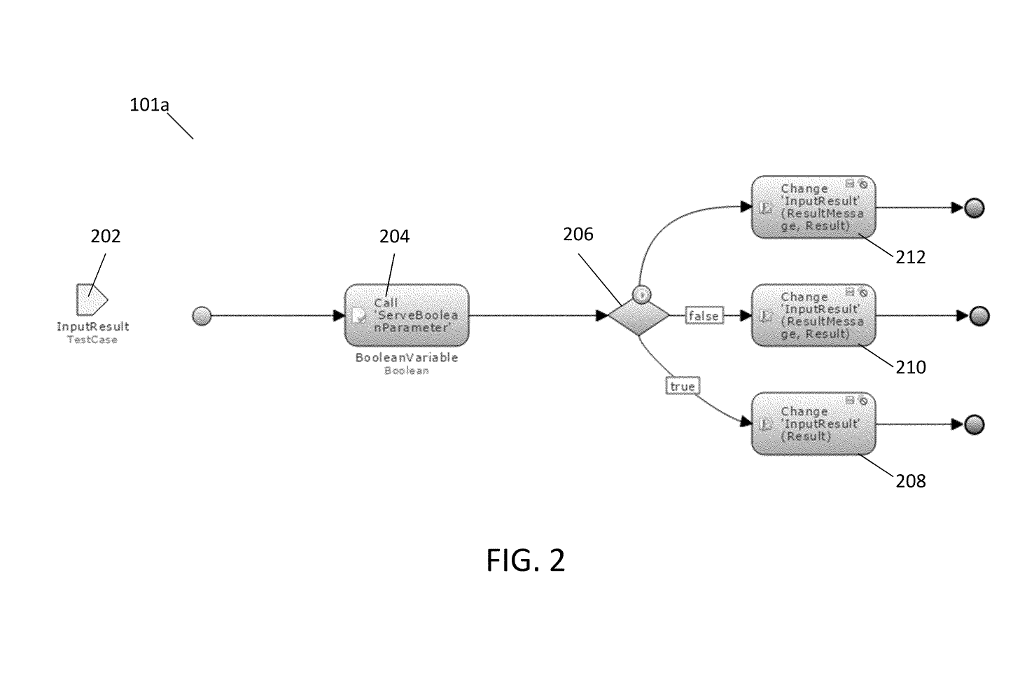

FIG. 2 depicts an exemplary visual representation 200 of a computer application or model, according to some embodiments. A user of a modeling environment can define the logic of an application by visually drawing the logic as indicated in this visual representation 200. In this example, visual representation 200 depicts a simple application for testing whether a received user input is a valid input. The application starts at element 202, which indicates that a user input is received. The application then proceeds to element 204, where a function named “ServeBooleanParameter” is called; this function tests whether the received user input is a valid input or not, and outputs a Boolean variable. The application proceeds to element 206, where the Boolean variable is tested. If the variable is true, the application branches to element 208, where a function ChangeInputResult is called, with a certain set of arguments. If the variable is false, the application proceeds to element 210, where the function ChangeInputResult is called with a different set of arguments. If the call to ServeBooleanParameter resulted in an error, the application branches to element 212, where the function ChangelnputResult is called with a pre-determined set of arguments. While FIG. 2 depicts a logic flow, visual representation 200 can also be used to represent other aspects of a visual model-based application, including the application's user interface, data storage models, integration transformations (e.g., interfaces with external applications such as web servers and APIs), etc.

In some embodiments, the disclosed visual model sharing system can convert an internal representation of a model into a visual representation of a model. The disclosed system can also enable modification of an internal representation based on a user's manipulation of a corresponding visual representation. The ability to freely convert between internal and visual representations of a model facilitates uploading, sharing, indexing, and searching of application models.

As discussed above, the internal representation can comprise data stored in a JSON format. In order to convert an internal representation into a visual representation, the disclosed system can execute a render function on this internal representation. This render function can implement the following steps: (i) parse the internal representation by iterating through each logical element; (ii) for each logical element, select a visual element to draw according to pre-defined mapping stored as part of the render function, and (iii) use Scale Vector Graphics (SVG) to draw the selected visual element. In some embodiments, the rendering function works as a translator from JSON format (used in the internal representation) to SVG (a language suitable for describing pictures and/or drawings in a browser). In some embodiments, the render function can also convert the internal representation to a plain text format. This plain text format can be provided to a search engine web crawler to facilitate in indexing key words associated with the model.

The disclosed system facilitates online sharing and collaboration on visual models by converting internal representations of models into visual representations, such as visual representation 200, that preserve important text and keywords (that provide functional information regarding all or part of the model) for indexing by existing search engines and crawlers (e.g., Google). For example, the conversion process can preserve the text within decision blocks, input/output blocks, and storage blocks in a flow diagram. In some embodiments, the conversion process can also preserve text that characterizes the overall structure of a visual model (e.g., characterizes the overall type or architecture of a model). The conversion process can also preserve text regarding details of the model that are required for execution of the model. In addition, comments and user and/or programmer documentation for the model is also included in the visual representation and available for indexing. As a result, visual representations can be easily uploaded, indexed, and searched in a meaningful way using existing search engines/algorithms.

In some embodiments, the conversion process can convert an internal representation of a model into a visual representation using JavaScript. In some embodiments, the visual representation can comprise an HTML webpage with embedded SVG (Scale Vector Graphics) elements, either in addition to or in place of JavaScript elements. In some instances, SVG can provide greater control and/or flexibility in displaying high-quality graphics in a visual representation compared to JavaScript. An HTML webpage with embedded SVG can be displayed by regular web browsers, and can also be interactive such that the user can directly manipulate the way the model is displayed and/or structured. As discussed above, for example, users can manipulate models shown in HTML/SVG webpages by hiding and/or disclosing certain parts of the model. Users can also zoom in and out of certain portions of the HTML/SVG webpages, focus on specific parts of the model, and click on parts of the model to disclose additional detail. Such additional detail can appear in the form of pop-ups or sliding windows that appear on-screen when the appropriate parts of the model are clicked. Users can also add branches of logic, delete branches of logic, or edit other elements of visual representation 200 by changing text, data parameters, or function calls, etc.

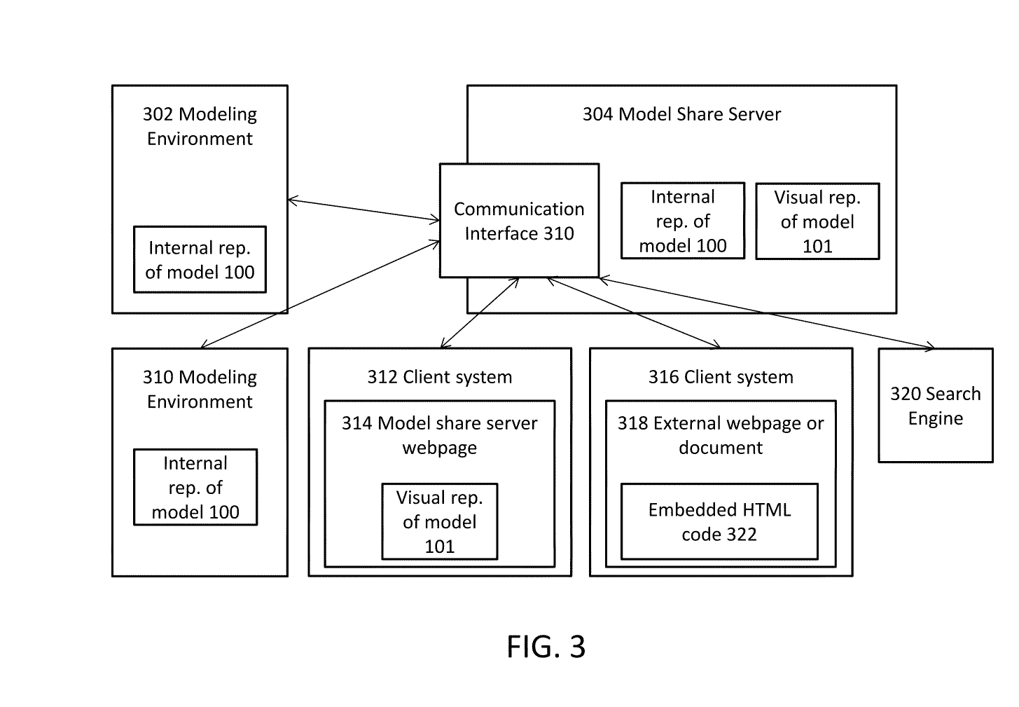

FIG. 3 is a conceptual block diagram illustrating some of the components of a system for editing, saving, and sharing visual and internal representations of models, according to some embodiments. FIG. 3 includes a model share server 304 having a communication interface 310 that is in communication with modeling environment 302, modeling environment 310, client system 312, client system 316, and search engine 320. In some embodiments, communication interface 310 communicates with the aforementioned systems via a network, such as the Internet, a cell network, an Ethernet network, or an intranet.

A user can use modeling environment 302 to design all or part of a software application. The modeling environment 302 can create or edit an internal representation of a model 100. The user of author modeling environment 302 can then share the model by uploading the internal representation 100 to model share server 304 via communication interface 310.

Model share server 304 can receive and store in memory the internal representation 100 from modeling environment 302. Model share server 304 can also generate one or more visual representations 101 corresponding to internal representation 100, and store the generated visual representations in memory. Model share server 304 can then share the stored internal and/or visual representations with other systems. For example, model share server 304 can share the internal representation 100 with another modeling environment 310, which can be associated with another user that is different from the original author. Model share server 304 can also host a webpage 314 that can be accessed by a client system 312 using, for instance, a web browser (not shown). The web page 314 can include the visual representation 101. Model share server 304 can also provide embedded HTML code 322 that can be embedded in an external webpage or document 318. External webpage or document 318 can be a webpage or other document that is not authored or hosted by model share server 304 (e.g., an online forum or blog), but which includes an embedded HTML code 322 provided by model share server 304. When external webpage or document 318 is opened or viewed, the embedded HTML code 322 can link back to model share server 304 to retrieve visual representation 101, and display visual representation 101 as part of the external webpage or document 318. Furthermore, model share server 304 can also communicate with a search engine 320. Model share server 304, as well as each of these ways of sharing models are described in further detail below.

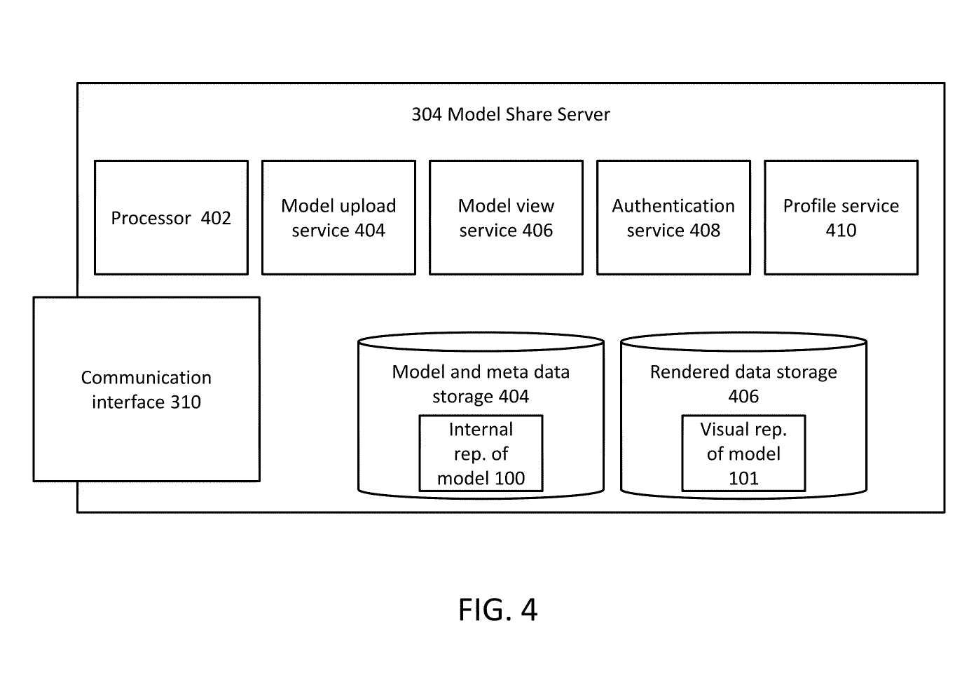

FIG. 4 is a conceptual block diagram depicting model share server 304 in greater detail, according to some embodiments. FIG. 4 includes the aforementioned communication interface 310, at least one processor 402, a model upload service 404, a model view service 406, an authentication service 408, a profile service 410, a model and meta data storage 404 that includes the aforementioned internal representation 100, and a rendered data storage 406 that includes the aforementioned visual representation 101.

Communication interface 310 can be configured to receive and send data to remote computer systems via a communication link. For example, communication interface 310 can be an interface that enables model share server 304 to connect to the world wide web. Processor 402 can be one or more processors that executes stored instructions to implement the functionalities of the model share server 304. In some cases, these functionalities can include some or all of the functionalities of model upload service 404, model view service 406, authentication service 408, and profile service 410 described herein. Model upload service 404 can be a service that accepts internal representations of models uploaded by users, such as internal representation 100 uploaded from author modeling environment 302, and transforms these uploaded internal representations into one or more visual representations. Model view service 406 can be a service which provides a visual representation to the browser of a viewer viewing the model online. In some cases, model view service 406 can be configured to host a webpage, such as webpage 314, that includes the visual representation 101. Model view service 406 can also be configured to respond to queries from web crawlers from search engines by providing site map resources that index some or all of the internal and visual representations of models stored in memory. Authentication service 408 can be a service which receives and verifies the identity and credentials of users sharing or downloading models, while profile service 410 can be a service that provides information about a user that is sharing and/or downloading a model. Each of model upload service 404, model view service 406, authentication service 408, and profile service 410 can be implemented as software instructions stored in memory that, when executed by processor 402, execute the described functionality. Each of these services can also be implemented as dedicated hardware devices using general purpose or special-purpose processors, or other specialized logic circuits such as ASICs. In some cases, one or more of these services can be implemented by a processor other than processor 402, including processors that are physically remote from model share server 304, but in communication with model share server 304 (via, for example, the Internet or an intranet). For example, one or more components of the model share server 304 can be implemented using cloud-based resources, whereby one or more of the described services are implemented on different, geographically dispersed, multi-purpose computing resources, such as processors, servers, and databases.

Model share server 304 can also include model and metadata storage 404, and rendered data storage 406. Model and meta data storage 404 can be any known data storage device, including volatile and/or non-volatile memory or database, that stores internal representations of models, such as internal representation 100, as well as information regarding such internal representations. Rendered data storage 406 can also be any known data storage device that stores visual representations of models, such as visual representation 101, as well as information regarding such visual representations. Although each of data storage 404 and 406 are shown as storing only one representation, it is understood that each data storage 404 and 406 can store an arbitrarily large number of internal and/or visual representations. Although depicted as separate data storage in FIG. 4, data storage 404 and data storage 406 can also be implemented in a single data storage device that stores both types of model representations.

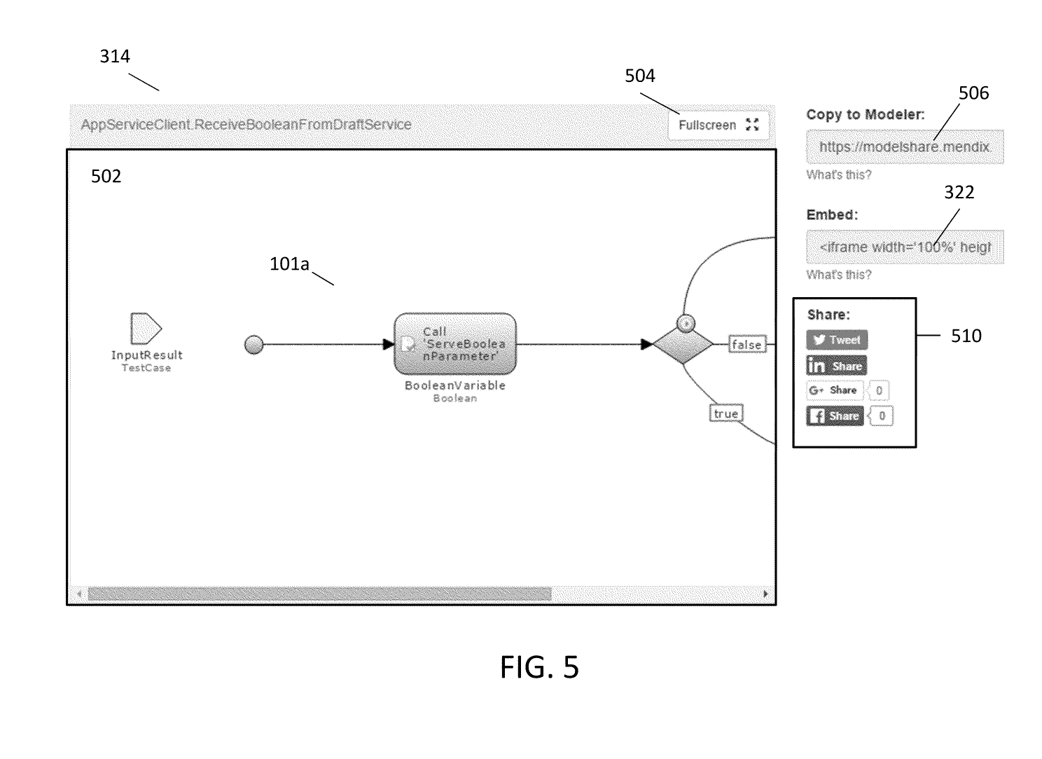

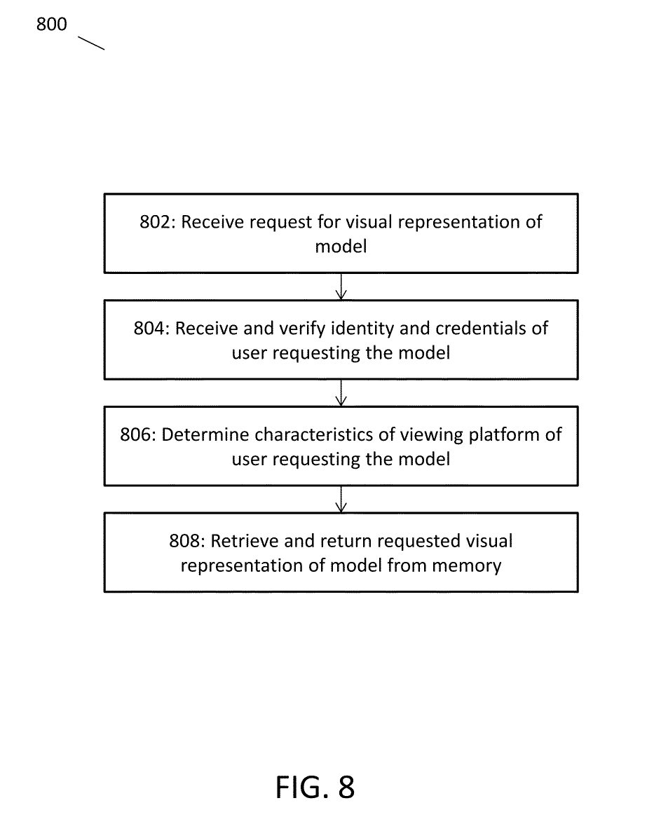

FIG. 5 shows an exemplary view of the aforementioned webpage 314 that can be hosted by model view service 406 of model share server 304, according to some embodiments. Webpage 314 can include a model view window 502 that depicts a selected visual representation of a model, such as visual representation 101a depicted in FIG. 2. The webpage 314 can also include a Fullscreen button 504 that, when clicked by a user, causes the model view window 502 to expand to fill all or substantially all of the available screen area. In some embodiments, model view window 502 can be implemented using HTML code incorporating SVG (Scale Vector Graphics) elements for visual display in a web browser. Webpage 314 can also detect parameters related to a platform being used to view webpage 314 (e.g., a size and/or dimension of an available viewing area), and depending on these parameters, customize webpage 314 to better display the visual representation. This is described in further detail below in relation to FIG. 8.

Webpage 314 can also include a resource identifier 506 as well as the aforementioned embed code 322. Resource identifier 506 can be a unique identifier that can be used to identify and/or access the internal representation of the model being displayed in model view window 502 (such as internal representation 100). In some embodiments, resource identifier 506 can be a Uniform Resource Locator (URL) that can be used to import the internal representation of the displayed model into a modeling environment, such as modeling environment 302 and/or 310. By accessing resource identifier 506, or by providing resource identifier to model view service 406 of web share server 304, a user can download all or part of the internal representation corresponding to the visual representation being displayed in model view window 506.

As discussed previously, embed code 322 can be a code that can be embedded by a user into an external web page or document (e.g., a web page or document that is not hosted and/or authored by web share server 304). When so embedded, embed code 322 can cause the external web page and/or document to display the visual representation shown in model view window 502. In some embodiments, embed code 322 can be an HTML code that causes the external web page and/or document to link back to web share server 304. When the external web page and/or document is viewed or opened on a client system (e.g., using a standard web browser or other document viewing software on client system 316 in FIG. 1), the client system can send a request to web share server 304 to provide the visual representation corresponding to the embed code 322. Web share server 304 can retrieve and return the requested visual representation, and the client system can display the visual representation as part of the external web page and/or document.

Webpage 314 can also include links 510 for sharing the displayed visual representation non various types of social media, such as Twitter, LinkedIn, Google+, and Facebook. In order to share the model depicted in view window 502, a user therefore has at least three options. First, the user can provide a URL associated with webpage 314 which, if clicked on or if entered into the location bar of a web browser, would lead another user to webpage 314. Second, the user can also provide URL 506, which allows another user to import the internal representation of the model into a modeling environment. Third, the user can embed or provide embed code 322 into an external webpage or document. Any or all of the URLs and/or embed codes described above can be shared using email, in text messages, or on social media websites. These URLs and/or embed codes can also be found using regular online search engines, as described in further detail below. Although not shown in FIG. 5, webpage 314 can also include information regarding the user (or users) which uploaded the model, which can be drawn from profile service 410.

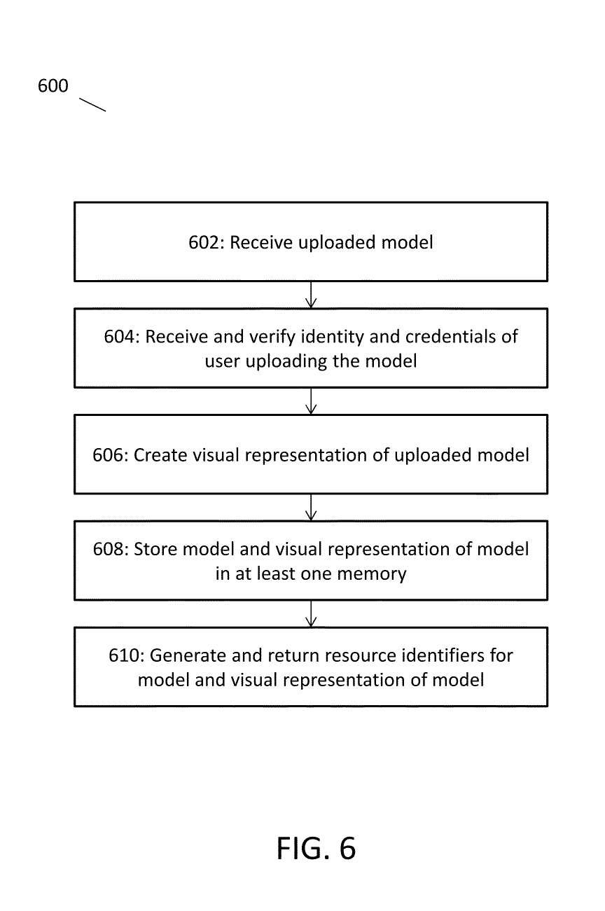

FIG. 6 is a flowchart depicting an exemplary process 600 for uploading, saving, and sharing internal and visual representations of models, according to some embodiments. The exemplary process 600 can be implemented at model share server 304 using model upload service 404, among other services. In some embodiments, a modeling environment, such as modeling environment 302 or 310, can offer users a way to select part of an application model and upload it model share server 304. At step 602, process 600 can receive all or part of an application model uploaded by a user from a modeling environment.

At step 604, process 600 can receive and verify the identity and credentials of a user uploading the model. In embodiments where process 600 is being implemented at model share server 304, this step can be implemented using authentication service 408 and/or profile service 410 to compare an identity and credentials received from a user against stored identity and credentials. If the user's identity and credentials cannot be verified, process 600 can be configured to prevent the user from uploading any models. If the user's identity and credentials can be verified, process 600 proceeds to step 606.

At step 606, process 600 can create a visual representation corresponding to the uploaded model. As previously discussed, in some embodiments, this visual representation (e.g., visual representation 101) can be browser compatible and can include HTML and SVG elements. This visual representation can be interactive. For example, the visual representation can be manipulated by a user to hide and/or display certain model details. The visual representation can also use HTML that enables embedding of the visual representation in other webpages. The visual representation can also provide model details to search engine crawlers to enable indexing of models to facilitate easier search and retrieval of models at a later time.

At step 608, process 600 can store both the uploaded internal representation as well as the generated visual representation into memory to enable efficient retrieval at a later time. In embodiments where process 600 is implemented at model share server 304, the internal representation can be stored in model and meta data storage 404, and the visual representation can be stored in rendered data storage 406.

At step 610, process 600 can generate and return resource identifiers for both the visual representation and the internal representation. For example, in embodiments where model share server 304 is used, the server 304 can generate and return resource identifier 506 (e.g., an identifier that corresponds to the internal representation) and embed code 322 (e.g., an identifier that corresponds to the visual representation) on webpage 314.

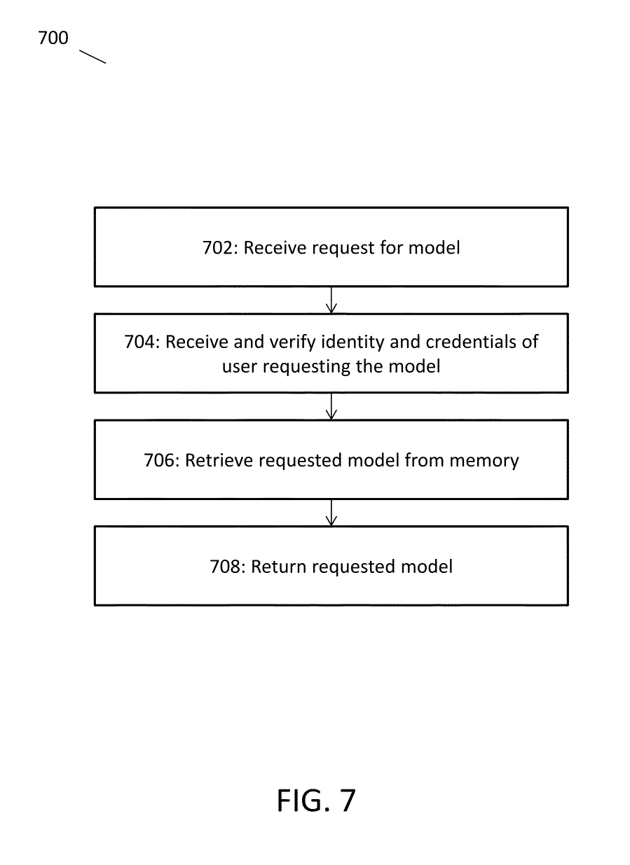

FIG. 7 is a flowchart depicting an exemplary process 700 for reusing a previously uploaded model, according to some embodiments. The exemplary process 700 can be implemented at model share server 304 using model view service 406, among other services. At step 702, process 700 can receive a request for an internal representation of a model. The request can include a specific resource identifier, such as resource identifier 506, that uniquely identifies an internal representation of a model stored in model and meta data storage 404. The request can be a request for all or part of the internal representation. In some cases, the request can be a request from a modeling environment to import all or part of the internal representation stored on model share server 304.

At step 704, the process 700 can receive and verify the identity and credentials of the user requesting the model. This step can also be implemented using authentication service 408 and/or profile service 410 to compare an identity and credentials received from a user against stored identity and credentials. If the user's identity and credentials cannot be verified, process 700 can be configured to prevent the user from viewing or downloading any models. If the user's identity and credentials can be verified, process 700 proceeds to step 706.

At step 706, the process 700 can retrieve the requested internal representation of the model (e.g., internal representation 100) from the model and meta data storage 404. If only part of a model is requested, the process 700 can retrieve only the requested part of the model.

At step 708, the process 700 can return the requested model to the user and/or system that originated the request in step 702. In some embodiments, if the request came from a modeling environment, the modeling environment can incorporate the retrieved internal representation into a project currently being modeled in the modeling environment.

FIG. 8 is a flowchart depicting an exemplary process 800 for viewing a visual representation of a model that was previously uploaded and/or generated, according to some embodiments. The exemplary process 800 can also be implemented at model share server 304 using model view service 406, among other services. At step 802, process 800 can receive a request for a visual representation of a model. The request can include a specific resource identifier, such as an embed code 322, or a URL linked to webpage 314. For example, a user could click on a hyperlink, or enter the specific resource identifier into the location field of a web browser.

At step 804, the process 800 can receive and verify the identity and credentials of the user requesting the model. This step can also be implemented using authentication service 408 and/or profile service 410 to compare an identity and credentials received from a user against stored identity and credentials. If the user's identity and credentials cannot be verified, process 800 can be configured to prevent the user from viewing or downloading any models. If the user's identity and credentials can be verified, process 800 proceeds to step 806.

At step 806, the process 800 can determine characteristics of a viewing platform associated with the user requesting the model. For example, model view service 406 can be configured to detect whether the requesting user's viewing platform is seeking to view the requested visual representation as part of an embedded webpage or in a full-screen view. In some embodiments, the model service can also detect whether the requesting user is using a desktop or mobile modeling environment, a size and/or aspect ratio of an available viewing surface being used by the requesting user, whether the user is using a desktop or mobile browser, the operating system being used by the requesting user, the type and version of browser being used by the requesting user, and other details regarding the requesting user's viewing/editing platform.

At step 808, the process 800 can retrieve and return the requested visual representation from memory. As discussed above, a single internal representation of a model can have multiple visual representations. In some embodiments, each type of visual representation can be suited for a different viewing/editing platform. Based on the determination in step 806, process 800 can provide different representations that are best suited for the requesting user's viewing/editing platform. In some cases, the requesting user can be a person requesting the visual representation for viewing on, for example, a web browser. In other cases, the requesting user can be a search engine crawler that requests a representation in order to index required information for future searches. In some embodiments, process 800 can determine whether the requesting user is a real person or a search engine crawler, and can tailor the visual representation(s) that it returns accordingly.

In some embodiments, the fact that multiple visual representations exist for the same model can be hidden from the user. For example, every shared visual representation that is associated with the same internal representation of a model can be grouped under the same URL (Uniform Resource Locator). When the requesting user navigates to that URL, the model view service (106) can automatically detect what viewing/editing platform is being used by the requesting user, and return the appropriate visual representation best suited to that viewing/editing platform. The requesting user therefore perceives that model view service (106) stores and returns only one model representation, when in fact there are multiple visual representations that are stored.

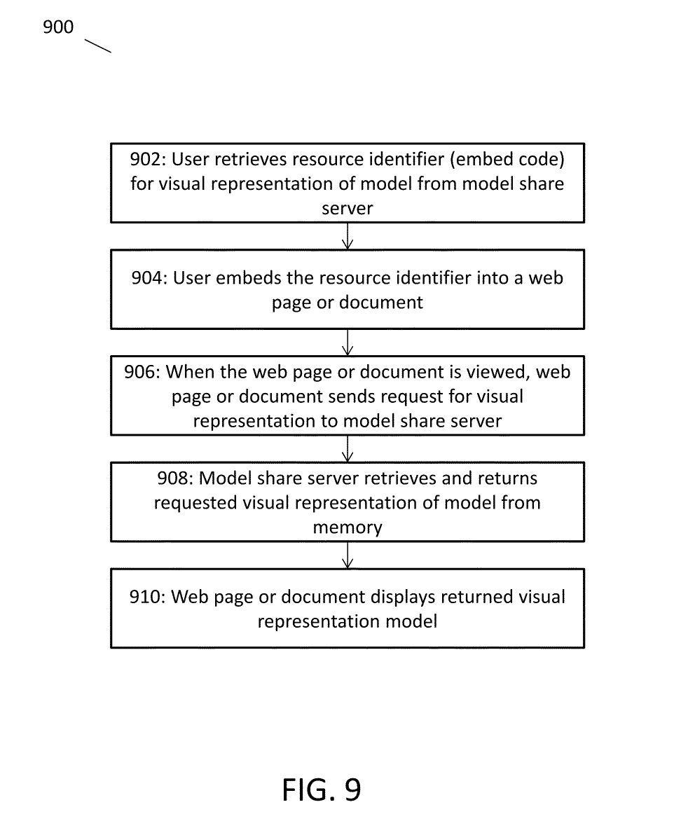

FIG. 9 is a flowchart depicting an exemplary process 900 for embedding a visual representation of a model into an external webpage or document, according to some embodiments. To facilitate sharing knowledge of visual models, visual representations of models can be embedded in web pages. Process 900 can be implemented by a user building an external webpage or document, in conjunction with model share server 304. At step 902, the user retrieves a resource identifier (e.g., embed code 322) for a specific visual representation stored on model share server 304. The user can retrieve this code from, for example, webpage 314, discussed above in relation to FIG. 5.

At step 904, the user can embed the resource identifier (e.g., embed code 322) into a web page or document. The embed code can be an HTML tag that adds functionality to the web page or document into which it is embedded.

At step 906, when the web page or document is viewed, the embedded resource identifier can cause the web page or document (or the web server, web browser, or other system on which the web page or document is being viewed or hosted) to send a request for the visual representation to the model share server 304.

At step 908, in response to the request, model share server 304 can retrieve and return the requested visual representation from memory (e.g., from rendered data storage 406). In some embodiments, model share server 304 can determine that the request originated from an external web page or document being viewed on a particular viewing/editing platform, and can return a visual representation that is suitable for display on that particular viewing/editing platform. Model share server 304 can use techniques similar to those discussed above for FIG. 7 to make these determinations. Also as discussed above, the requested model can be an HTML webpage with SVG elements.

At step 910, when the web page or document (or the web server, web browser, or other system on which the web page or document is being viewed or hosted) receives the requested visual representation, the web page or document displays the visual representation as part of its content.

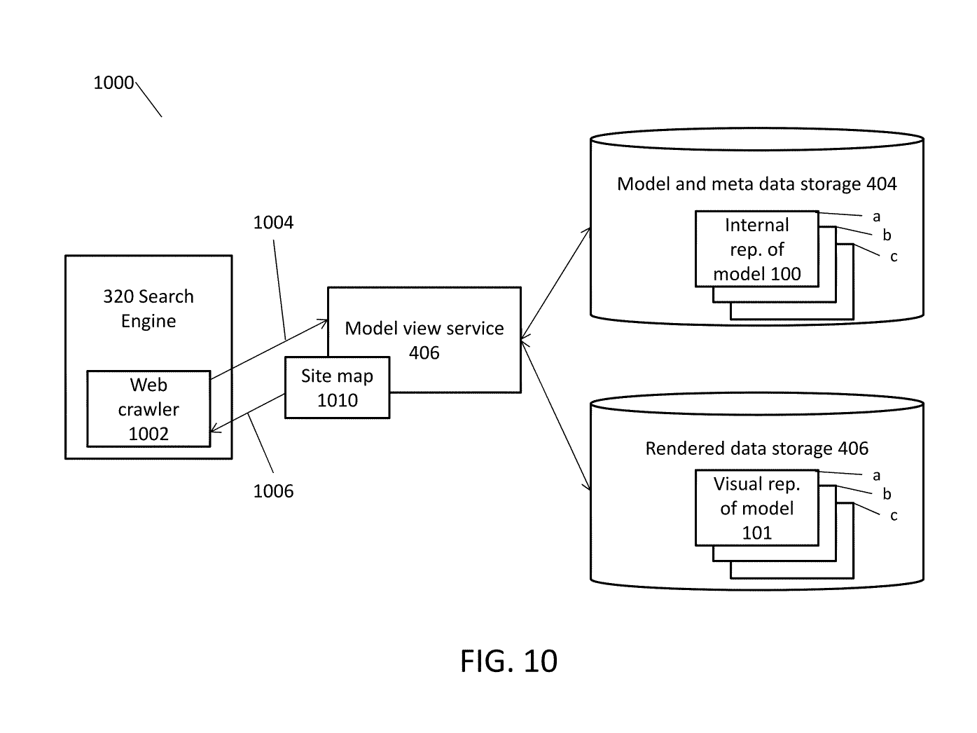

FIG. 10 is a data flow diagram that depicts an exemplary data flow progression 1000 associated with an indexing operation by a web crawler, according to some embodiments. In these data flows, a web crawler indexes models stored by model share server 304. FIG. 10 includes the aforementioned search engine 320, which includes a web crawler 1002. A web crawler is an application or program which browses the World Wide Web in a methodical, automated manner. Web crawlers can be used by search engines to update their web content or indexes of other web sites' web content to facilitate comprehensive, and accurate searching.

Shared models can be found through internet search engines. To facilitate this, model share server can provide information to web crawlers that can be used by search engines to determine what is displayed in a shared model. This information can include, for example, text preserved during the conversion process from an internal representation to a visual representation. The preserved text can include text in flowcharts and decision trees, text that characterizes the overall architecture or type of model, and/or text from comments and user documentation for the model.

At intervals, web crawler 1002 from search engine 320 can request a site map resource from model view service 406 of model share server 304. This request is illustrated as dataflow 1004. The site map resource can be used by the web crawler to determine and/or index the content being shared or hosted on model share server 304. In response to, or in anticipation of, this request, model view service 406 can access the stored internal representations in model and meta data storage 404—these are depicted as internal representations 100a-c. Model view service 406 can also access the stored visual representations in rendered data storage 406—these are depicted as visual representations 101a-c. Model view service 406 then generates a sitemap resource 1010. In some embodiments, this resource can be an XML resource (e.g., “sitemap.xml”), although other formats for sitemap resource 1010 are also possible. This sitemap resource 1010 can include information, or links to web resources that include information, regarding some or all internal and visual representations of models stored in model share server 304. The model view service 406 can then return site map 1010 to web crawler 1002 via dataflow 1006. Web crawler 1002 then indexes the sitemap resource (or the web resources that the sitemap resource links to) to determine keywords used in the shared models. This indexing operation can facilitate more comprehensive searches for keywords or terms associated with models stored on model share server 304 by search engine 320.

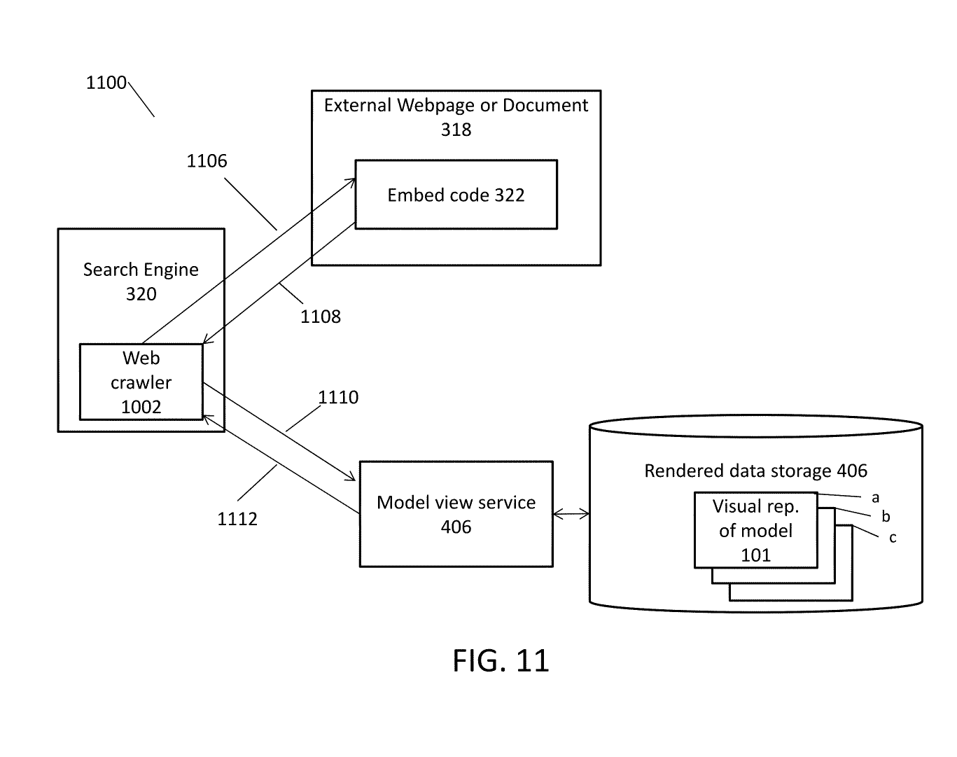

FIG. 11 is a data flow diagram that depicts an exemplary data flow progression 1100 associated with an indexing operation of an external webpage or document by a web crawler, according to some embodiments. As with FIG. 10, FIG. 11 also includes the aforementioned search engine 320 and web crawler 1002.

At intervals, web crawler 1002 can visit external webpage or document 318. This visit is depicted as dataflow 1106. As discussed previously, this external webpage or document 318 can include an embed code 322 which corresponds to a visual representation of a model. The embed code 322 in the external webpage or document 318 can include an HTML representation of a shared model. The embed code 322 can also include a resource identifier that points towards the model view service 406 in model share server 304. In some embodiments, this resource identifier can take the form of an iframe.

In response to the visit from web crawler 1106, external webpage or document 318 can return information pointing web crawler 1002 to the model view service 406. This returned information is depicted as dataflow 1108.

The crawler 1002 then requests the shared model identified by the embed code 322 from model view service 406, as depicted in dataflow 1110.

In response to the request from the crawler 1002, model view service 406 retrieves the visual representation corresponding to embed code 322 from rendered data storage 406. Model view service 406 then returns the embedded visual representation to web crawler 1002 via dataflow 1112. Crawler 1002 can then index the visual representation to determine keywords used in model embedded in external webpage/document 318.

While processes and/or data flow progressions 600, 700, 800, 900, 1000, and 1100 have been described above in terms of certain exemplary steps, these steps can be modified in various ways. The exemplary steps depicted and described above can be rearranged, deleted, duplicated, and/or otherwise modified, and additional intervening steps can be added. For example, all steps related to receiving and verifying an identity of a user uploading and/or downloading a model (e.g., step 606, 704, and 804) are optional and can be omitted in certain embodiments that facilitate free, anonymous sharing of models. In some embodiments, if an identity of an uploading or downloading user cannot be verified, the system can be configured to grant the user only limited uploading and/or downloading permissions (e.g., only allow uploading and/or downloading models below a certain size, or of a certain type, or only a certain number of times). The system can also be configured to grant full uploading and/or downloading permissions to users whose identities cannot be verified, but to label these users as anonymous users.

Additional steps can be added as well: for example, information regarding a user uploading a model can be stored along with the uploaded model, and then provided to a second user downloading the model. Users uploading models can also specify whether all or only a specified part of the uploaded model should be saved into memory (e.g., model and meta data storage 404, and/or rendered data storage 405). Similarly, users downloading models can also specify whether all or only part of a saved model should be downloaded. Model share server 304, and the processes/data flow progressions described above, can also be modified to enable users to search for models using various keywords, and/or organize uploaded models according to various categories, such as model type, application type, architecture type, size, date of upload and/or creation, number of downloads, popularity, identity of uploading user, identity or identities of downloading users, etc. In some embodiments, model share server 304 can also automatically compute, receive, store, and/or display data regarding saved models. For instance, model share server 304 can compute, receive, store, and/or display metrics related to a model's quality, applicability to certain applications, maintainability, and performance.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor can receive instructions and data from a read only memory or a random access memory or both. The essential elements of a computer are a processor for executing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube), LCD, OLED, AMOLED, IPS, and/or TFT display, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims.

1. A system for facilitating sharing of a visual model-based application over a network, the system comprising:
a communication interface configured to communicate with at least an uploading user and a downloading user over the network;
at least one memory; and
at least one processor configured to:
receive, from the uploading user, via the communication interface, an internal representation defining an operation of the application, wherein the internal representation is configured to be read and edited by a visual model-based application modeling environment,
convert the internal representation into a visual representation of the application, wherein the visual representation visually depicts a logic flow associated with the internal representation, the logic flow comprising one or more elements that are configured to interact with a viewing user,
store the received internal representation and the visual representation into the at least one memory, and
provide, via the communication interface, at least one of the visual representation and the internal representation to the downloading user.

2. The system of claim 1, wherein the at least one processor is further configured to
generate a first resource identifier associated with the internal representation, and a second resource identifier associated with the visual representation;
host a webpage that displays the first resource identifier and the second resource identifier;
provide the internal representation in response to a request associated with the first resource identifier; and
provide the visual representation in response to a request associated with the second resource identifier.

3. The system of claim 1, wherein the visual representation comprises Scale Vector Graphics (SVG) elements.

4. The system of claim 2, wherein the second resource identifier is an HTML object configured to be embedded in an external webpage or document.

5. The system of claim 1, wherein the at least one processor is further configured to provide a sitemap resource to a search engine web crawler, the sitemap resource including links to keywords that characterize at least one of the internal representation and the visual representation.

6. The system of claim 1, wherein the at least one processor is further configured to receive and verify an identity and a credential associated with at least one of the uploading user and the downloading user.

7. The system of claim 1, wherein the one or more elements are configured to interact with a viewing user by displaying more or less text when clicked on.

8. The system of claim 1, wherein the one or more elements are configured to interact with a viewing user by being configured to allow the user to move the one or more elements from one part of the visual representation to another part of the visual representation.

9. The system of claim 1, wherein the visual model-based application comprises an application module configured to be combined with other application modules.

10. A method for facilitating sharing of a visual model-based application over a network, the method comprising:
receiving, at at least one processor from an uploading user via a network, an internal representation defining an operation of the application, wherein the internal representation is configured to be read and edited by a visual model-based application modeling environment;
converting, at the at least one processor, the internal representation into a visual representation of the application, wherein the visual representation visually depicts a logic flow associated with the internal representation, the logic flow comprising one or more elements that are configured to interact with a viewing user;
storing the received internal representation and the visual representation into at least one memory; and
providing, via the network, at least one of the visual representation and the internal representation to a downloading user.

11. The method of claim 10, further comprising:
generating a first resource identifier associated with the internal representation, and a second resource identifier associated with the visual representation;
hosting a webpage that displays the first resource identifier and the second resource identifier;
providing the internal representation in response to a request associated with the first resource identifier; and
providing the visual representation in response to a request associated with the second resource identifier.

12. The method of claim 10, wherein the visual representation comprises Scale Vector Graphics (SVG) elements.

13. The method of claim 11, wherein the second resource identifier is an HTML object configured to be embedded in an external webpage or document.

14. The method of claim 10, further comprising providing a sitemap resource to a search engine web crawler, the sitemap resource including links to keywords that characterize at least one of the internal representation and the visual representation.

15. The method of claim 10, further comprising receiving and verifying an identity and a credential associated with at least one of the uploading user and the downloading user.

16. The method of claim 10, wherein the one or more elements are configured to interact with a viewing user by displaying more or less text when clicked on.

17. The method of claim 10, wherein the one or more elements are configured to interact with a viewing user by being configured to allow the user to move the one or more elements from one part of the visual representation to another part of the visual representation.

18. The method of claim 10, wherein the visual model-based application comprises an application module configured to be combined with other application modules.
